(19) United States
(12) Patent Application Publication
(10) Pub. No.: US 2011/0178927 A1
(43) Pub. Date: Jul. 21, 2011

(54) VERIFICATION MECHANISM

(76) Inventors: Mike Lindelsee, Redwood City, CA (US); Olivier Brand, Walnut Creek, CA (US); James Dimmick, Foster City, CA (US); Benedicto Dominguez, San Bruno, CA (US)

(21) Appl. No.: 13/009,419

(22) Filed: Jan. 19, 2011

Related U.S. Application Data
(60) Provisional application No. 61/296,395, filed on Jan. 19, 2010.

(51) Int. Cl. G06Q 40/00

(52) U.S. Cl. 705/44

(57) ABSTRACT

Systems, apparatuses, and methods for receiving a verification message with information that includes a first portion but not a second portion of an account identifier associated with an account of a consumer. Upon receiving the verification message, searching for the account using the information of the verification message.

### CROSS-REFERENCES TO RELATED APPLICATIONS

This application claims priority from U.S. Provisional Appl. No. 61/296,395, filed Jan. 19, 2010, which is incorporated herein by reference in its entirety for all purposes.

### BACKGROUND

Enrollment into a service typically involves some verification process that confirms the identity of the person enrolling. Such a process is generally performed by the entity offering the service. In the case of an issuer financial institution that offers payment cards (e.g., a credit, debit, or stored value card), the issuer financial institution may perform some method of verification. For example, the financial institution can verify a consumer's ownership of an account by requesting confirmation of a secret code, such as a password, answer to a secret question, or information on past transactions.

It has now become common for a financial institution to offer a service to their consumers, wherein the service is performed in at least in part by another entity. Such an entity can be referred to as a service provider, as is described below. The service provider may provide the service on behalf of multiple financial institutions or, in other cases, may provide multiple services that a consumer may enroll in separately through their financial institution. In such cases, however, there does not exist any method for confirming that the identity of the consumer is consistent from one enrollment to the next. Such may be the case where the enrollment is across issuer financial institutions.

Further, it has now become common for some third parties to provide enrollment interfaces on behalf of the financial institution. Accordingly, where enrollment involves exchanging sensitive information, the third party enrollment interface may be a security risk.

Embodiments of the present invention address these and other problems, individually and collectively.

### SUMMARY

Embodiments of the present invention are directed to systems, apparatuses, and methods for verifying subsequent enrollment of a consumer in a service provided by a service provider on behalf of an issuer. More specifically, embodiments of the invention are directed to a system, apparatus, and method for verifying a subsequent enrollment by searching enrollment database using a partial account identifier. The partial account identifier may include a first portion of the account identifier but not a second portion. The partial account identifier may be, for example, the last four characters of an account identifier associated with a payment account.

Embodiments of the invention are further directed to a method for receiving a verification message with information that includes a first portion but not a second portion of an account identifier associated with an account of a consumer. Upon receiving the verification message, a computer apparatus may search for the account using the information of the verification message.

In another embodiment, the present invention is directed to an apparatus and/or system configured to execute a method for receiving a verification message with information that includes a first portion but not a second portion of an account identifier associated with an account of a consumer. Upon receiving the verification message, a computer apparatus may search for the account using the information of the verification message.

The advantages of embodiments of the present invention will be apparent to one of ordinary skill in the art upon review of the detailed description of the present invention and the included figures.

### BRIEF DESCRIPTION OF THE DRAWINGS

FIG. 1 is a block diagram illustrating the primary elements of a system for enrolling a consumer in a service provided by a service provider on behalf of an issuer, in accordance with some embodiments of the present invention;

FIG. 2 is a diagram illustrating the primary functional elements of an enrollment system enrolls a consumer in a service, in accordance with some embodiments of the present invention;

FIG. 3 is a block diagram illustrating a data model of a consumer record, in accordance with some embodiments of the present invention;

FIG. 4 is a diagram illustrating the primary functional elements of an enrollment system that subsequently enrolls a consumer in a service, in accordance with some embodiments of the present invention;

FIG. 5 is a diagram showing an exemplary interface requesting verification information from a consumer during a subsequent enrollment at a service provider, in accordance with some embodiments of the present invention;

FIGS. 6a and 6b are flow diagrams showing a general method for verifying a consumer subsequently enrolling in a service, in accordance with some embodiments of the present invention; and

FIG. 7 is a block diagram illustrating the primary functional components of a computer or computing system that may be used to implement an element or component used in some embodiments of the present invention.

### DETAILED DESCRIPTION

Embodiments of the present invention are directed to methods, apparatuses, and systems for searching an enrollment database with a partial account identifier and determining whether a consumer previously enrolled in a service based on matching the partial account identifier with account identifiers associated with the consumer. In some embodiments, such methods, apparatuses, and systems are used during a subsequent enrollment of a consumer in a service. A subsequent enrollment can occur when a consumer enrolls in the service with a different issuer or with the same issuer but different account or different service.

As used herein, an “issuer” can refer to any entity that issues an account associated with a consumer. A bank, or other financial entity, that provides financial accounts to consumers to track or otherwise record financial transactions between the consumer and the bank is an example of an issuer. Accounts can be identified uniquely using an account identifier, such as any alpha numerical string.

In some embodiments, an issuer may provide a service with respect to an account. As described herein, a “service” can refer to any suitable activity that operates on, with regards to, or otherwise associated with an account maintained by an issuer. As an example, in the case of a financial account, authorization of a request to debit funds from an account is an example of a service. Other services can include alerts based on specified trigger criteria, rewards program, automatic electronic statements and balance notices, reoccurring withdrawals, mobile banking, etc.

Specific examples of services are described in greater detail below. In some embodiments, a service offered by the issuer is performed at least partially by a service provider. Authorization of a payment request from a credit card (e.g., as occurs when a consumer swipes the credit card at a merchant's store) is an example of a service provided at least in part by a service provider because a payment card network (e.g., VISA or MASTERCARD) performs some part of the operation of authorizing the payment on behalf of the issuer.

An issuer can provide an interface for consumers to enroll in a service offered by the issuer. Even if the service is performed at least in part by a service provider on behalf of the issuer, interaction with the enrollment interface can be seamless with the interaction with the issuer. For example, the enrollment interface screen can be branded with issuer logos and trade dress. In some embodiments, a third party operates the enrollment service on behalf of the issuer. As part of the enrollment process, a consumer may select or otherwise provide an alias that identifies the consumer. A phone number, email, user name, or any combination thereof can be used as an alias. Issuers may associate a consumer with the same alias across all services that the consumer enrolls in. For example, a consumer may use their email address as an alias for an online authentication service, and then use the email address for another service, such as an online offer and coupon service. Using either service, the consumer may be identified using the email address.

A consumer's alias, and other information, can be centrally stored by the service provider. This allows for the uniqueness of aliases to be maintained across issuers and across services provided by the service provider on behalf of the issuer. As such, the service provider can act as the central repository for consumer enrollment data.

According to example embodiments, when a consumer requests a subsequent enrollment with a service provider, the service provider or issuer may verify that the consumer is the same consumer that enrolled with the previous account. A subsequent enrollment may occur if a consumer enrolls an additional account from the same issuer, an account from a different issuer, or the same account but with a different service offered by the issuer. To verify the consumer, the consumer may provide a partial account identifier of the account previously enrolled with the service provider.

As used herein, a “partial account” identifier can refer to any representation of an account identifier that lacks at least one portion of the actual account identifier. For example, a number that includes the first six and last four, but not the middle, characters of an account identifier can be a partial account identifier. Using the partial account identifier, the service provider may search an enrollment database for enrollment information corresponding to the consumer, and may verify that the partial account identifier matches the previously enrolled account identifier.

Verifying a consumer using a partial account identifier of a previously enrolled account identifier has a number of advantages. To begin, the actual account identifier can be sensitive data that can allow a fraudster to misappropriate funds, for example, from a consumer's account maintained by the issuer. Obtaining and transmitting a partial account identifier during an enrollment process reduces the risk that a fraudster may obtain sensitive information. This is an advantage because, as described above, a third party may provide the enrollment interface on behalf of the issuer. In addition, such account information may be transmitted over a network, such as the Internet. Thus, embodiments of this invention limit the occasions where the consumer submits sensitive information not only to a third party, but also over a network such as the Internet.

In another way, where various account information are linked together (e.g., if a single alias links multiple services potentially across issuers), verifying a previously enrolled account reduces the risk that a fraudster can obtain access to previous enrollment data and/or services simply by enrolling another account (e.g., a token account) with an alias associated with a consumer's already enrolled accounts.

### I. Example Service

To clarify the discussion of embodiments of the invention, a specific service is now described. The service provider may provide a remote payment service that authenticates payment requests made when a consumer purchases items through a merchant web site. In particular, using the remote payment service, a consumer may visit a merchant's website to purchase items. As part of the checkout process provided by the merchant website, the consumer may request to purchase items for sale using the remote payment service that they are enrolled in. The request sent by the consumer's web browser, for example, may include an alias (e.g., a phone number or email address) that the remote payment service may use to identify the consumer enrolled in the service. The association between the consumer and the alias can be established prior to the payment request, e.g., when the consumer enrolls with the remote payment service, as may be provided by an enrollment website of the issuer. Once the remote payment service receives the request to purchase the items, the remote service can provide the merchant website various nicknames associated with accounts of the consumer. “MyRedCard” is an example of a nickname that a consumer can assign to their account. The consumer can then select an account nickname when they purchase an item through the merchant website. The selection of the account nickname is transmitted to the remote payment service and the remote payment service then provides the merchant with account details for the account associated with the selected nickname. In this way, the sensitive account identifiers are not exchanged through the merchant website. Instead, the account information is transferred from a more secure path between the service provider and the merchant systems.

### II. High Level System Description

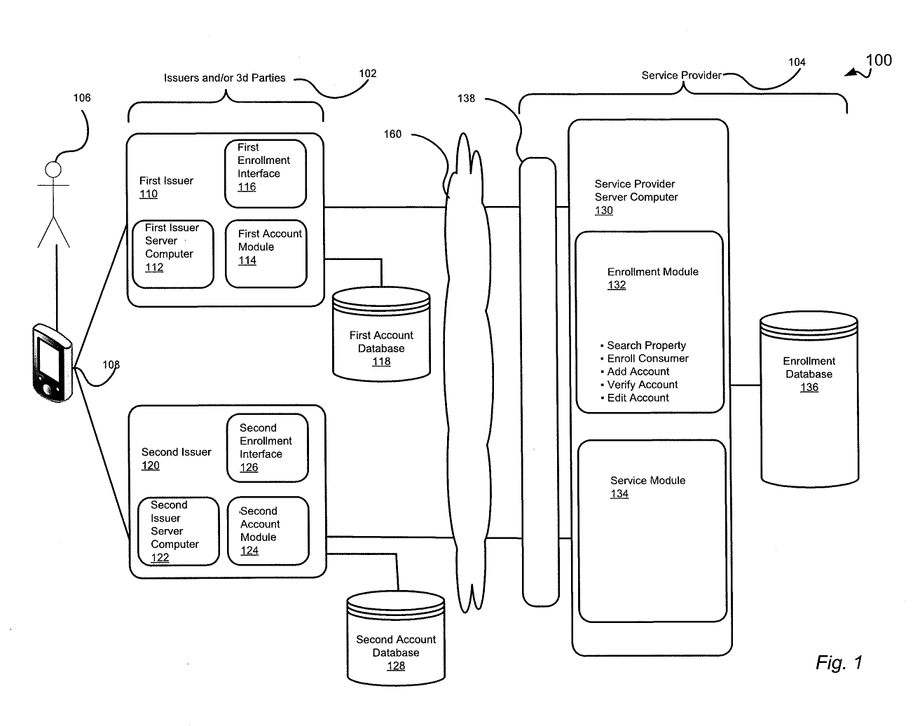

Prior to further discussing the verifying a consumer based on a partial account identifier, a brief description of an example enrollment system will be presented. FIG. 1 schematically illustrates one embodiment of an enrollment system 100 that verifies a subsequent enrollment by a consumer. In one embodiment, a subsequent enrollment can occur when a consumer enrolls in one service provided by a service provider on behalf of an issuer and then another service provided by the service provider on behalf of another issuer. In other embodiments, a subsequent enrollment can occur when a consumer enrolls in one service offered by a service provider on behalf of an issuer and then enrolls in another service offered by the service provider on behalf of the issuer.

The enrollment system 100 shown in FIG. 1 can be divided into two segments, issuers and/or third parties 102 and a service provider 104. As described in greater detail below, communication between the issuers and/or third parties 102 and the service provider 104 allows a consumer to enroll in a service provided in part by the service provider 104 with respect to accounts maintained by an issuer. In this way, the service provider 104 can provide services to consumers on behalf of multiple issuers.

A consumer 106 interacts with the issuers and/or third parties 102. Consumer 106 can be a person or an entity such as a business that has an account with an issuer 110 or 120. As FIG. 1 shows, the consumer 106 may communicate with the client computer 108, which may include a mobile device such as a PDA, mobile cell phone, tablet, etc.

The issuers and/or third parties 102 may include components that are primarily controlled by an entity (e.g., an issuer) that provides and otherwise manages an account associated with consumer 106. As FIG. 1 shows, there can be one or more issuers, such as first and second issuers 110 and 120. In some embodiments, components of the issuers and/or third parties 102 can be controlled by a third party. As an example, an issuer can have a third party operate a third party enrollment website to avoid the complexities of the enrollment process.

As shown in FIG. 1, the first issuer 110 may operate a first enrollment interface 116, a first account module 114, a first issuer server computer 112, and a first account database 118. Additionally, a second issuer 120, can include similar components including a second issuer server computer 122, a second account module 124, a second enrollment interface 126, and a second account database 128. Descriptions of the components associated with the first issuer 110 are provided below, and the descriptions similarly apply to the corresponding components of the second issuer 120.

The first issuer server computer 112 can be a computer apparatus that manages activity related to its accounts, such as consumer enrollment for a service provided by the service provider 104. The first enrollment interface 116 can be a web based interface (e.g., web pages) or an application interface. The first enrollment interface 116 may verify a consumer's identity using an alias. For example, the first enrollment interface 116 may verify the identity of the consumer using a phone number or any other criteria. Verifying the consumer is described in greater detail below. The first enrollment interface 116 also obtains enrollment information from the consumer and then transmits the enrollment information to the service provider 104. As described below, the service provider 104 may store the enrollment information in a consumer record associated with the consumer 106.

In some embodiments, a third party enrollment service (not shown) may operate the first enrollment interface 116, or at least some portion thereof. In such embodiments, the third party enrollment service can process and manage the enrollment of consumers on behalf of issuers. Such third party enrollment services may provide enrollment services to one or more issuers (e.g., two or more different issuers). As such, a third party enrollment service may provide a common interface to the service provided by the service provider across multiple issuers.

Enrollment information may be received from the consumer 106 and verified by the different components of the enrollment system 100. As shown in FIG. 1, the first issuer 110 operates the first issuer server computer 112. However, a service organization, such as Visa, or a third party provider of an enrollment service may operate at least some aspect of the first issuer server computer 112 on behalf of the issuer. For example, the first issuer 110 may use a web-enabled, interactive “identity authentication service” provided by a third party during the enrollment process to help validate a consumer's identity.

The first account database 118 can be an issuer managed database that stores information relating to the consumers. The first account module 114 controls access to the account database 118. As such, the first issuer 110 may verify consumer information based on records stored in the first account database 118. Information stored in the first account database 118 is not necessarily available to other entities. For example, the second issuer 120 may not be able to directly access the first account database 118 in all instances

The second issuer 120 includes components similar to the components of the first issuer 110. Typically, the first and second issuers 110, 120 do not share information as they are separate entities.

The service provider 104 includes components that can be primarily controlled by an entity that provides services on behalf of the first and second issuers 110, 120 with respect to the accounts associated with the consumer 106 and maintained by the issuer. Such an entity can be referred to as a “service provider.” A service provider, as an example, can be a payment card processing network, such as VISA or MASTERCARD. In addition to being a payment card processing network, a service provider may be any suitable service entity such as those described above. The service provider 104 includes a service provider server computer 130 that can be one or more computer apparatuses that run an enrollment module 132 and a service module 134. The service provider 104 may also include a service infrastructure 138 that connects to the issuers via a network 160 (e.g., the Internet or any other suitable network). The service infrastructure 138 may include any suitable combination of hardware and software, and may be a communication gateway to the service provider 104.

The enrollment module 132 can enroll a consumer in a service provided by the service provider on behalf of the issuer. The enrollment module 132 provides centralization of consumer enrollment information at the service provider. The enrollment module 132 can store enrollment information in an enrollment database 136. The enrollment module 132 communicate to issuers through service infrastructure 138 to search, create, update, and delete a consumer's enrollment profile stored in the enrollment database 136. The service infrastructure 138 provides message authentication, authorization, message format processing, and denial of service protection measures for messages exchanged between the service provider 104 and the issuers and third parties 102. Maintaining enrollment data at the service provider allows the service provider to quickly verify a consumer's identity where the identity can be configured to work with multiple issuers.

The service module 134 can provide a service on behalf of the first and second issuers 110, 120 for consumers enrolled through the enrollment module 132. To illustrate, the exemplary service described above may perform functions that facilitate remote payments through a merchant's website, as described above.

### III. Enrollment

The description will now provide further detail regarding various phases from an initial enrollment to a subsequent enrollment. In particular, during the subsequent enrollment, the enrollment module 132 may verify that the consumer previously enrolled in the service using a partial account identifier.

a. Initial Enrollment

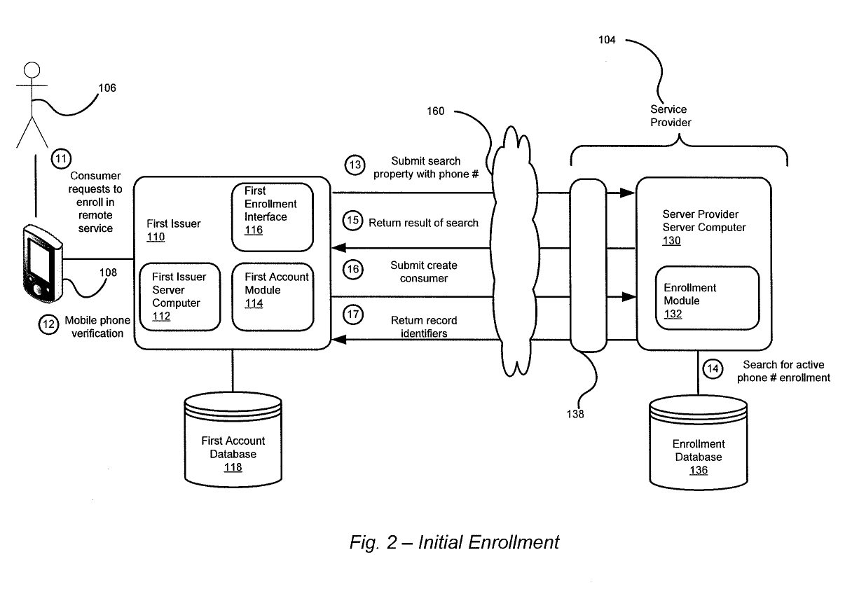

FIG. 2 illustrates functional elements involved in enrolling consumer 106 in a service offered by a service provider 104 on behalf of a first issuer 110. To begin, consumer 106 visits the first enrollment interface 116 provided by the first issuer 110. For example, the consumer may visit an issuer branded website that invites the consumer to enroll their card in a particular service. At this issuer branded website, the consumer may enter enrollment information such as a primary account identifier, phone number, name, expiration date, mailing address, email address, shopper identification, account verification value (e.g., CVV2), and consumer password. The enrollment interface may be accessed via the client computer 108. In this example, the client computer 108 may be in the form of a communication device such as a mobile phone. The consumer 106 requesting to enroll in the service is shown as message 11.

After the consumer 106 requests enrollment in a service offered by first issuer 110, the first issuer 110 may confirm ownership of the mobile phone number. This is shown as message 12. In some embodiments, the first issuer 110 confirms ownership of the phone number using an out-of-band process. For example, the first issuer 110 may call the number to retrieve personal information from a person that answers the call. This personal information may be verified by the issuer 110 using the information stored in the account database 118.

Once ownership of the mobile phone is confirmed, the first issuer 110 can determine whether the consumer 106 is already registered in the service. To confirm enrollment, the first issuer 110 may transmit a search request to the enrollment module 132 of the service provider 104. This is shown as message 13. In one example embodiment, the first issuer 110 transmits a “search property request” to the enrollment module 132. The search property request can refer to a request for the enrollment module 132 to search for a consumer record stored in the enrollment database 136 based on a property. A phone number is an example of a search property. An e-mail address is another example of a search property that can form the basis of a search property request.

Responsive to receiving a search request, the enrollment module 132 then searches database 136 to determine whether a consumer record with a property record that matches the search property exists. This is shown as message 14. Enrollment module 132 can further determine whether the phone number not only exists but the phone number is also enabled. An enabled phone number signifies that the phone number is currently enrolled in the service and usable as an alias.

Enrollment module 132 then responds to the issuer 110 with an indication of whether a consumer record is found, as shown as message 15. The response to the search request may be based on whether a consumer record matching the search property is found. For example, if a consumer record is found, the enrollment module 132 can return a positive indication that a consumer record was found. A consumer key (described below) can be used by the enrollment module 132 to identify the matching record. To return an positive indication that a consumer record is found, the enrollment module 132 can return the consumer key. Alternatively, if a matching consumer record is not found, the enrollment module 132 can return a negative indication that signifies that the consumer record was not found. Empty or null values are examples of such negative indication that signify that an account is not yet enrolled in the service.

Responsive to receiving an indication that a matching consumer record was not found, issuer 110 then transmits a “Create Consumer” request to the enrollment module 132. This is shown as message 16. The create consumer request may include additional consumer information, such as an indication that terms and conditions were agreed upon by the consumer 106, an alias (e.g., a phone number or email address), and account identifier enrollment information.

The enrollment module 132 then creates the consumer record in the enrollment database 136. A consumer record may include various fields or records to identify a consumer record. In some embodiments, identification of a consumer record can be direct. For example, some embodiments may use a consumer key that uniquely identifies the consumer record. Such a key may be used to lookup a record stored in a database. In other embodiments, identification of a record can be indirect. For example, a consumer record may be indirectly identified by searching for consumer records with certain properties, such as those consumer records that are associated with a particular phone number.

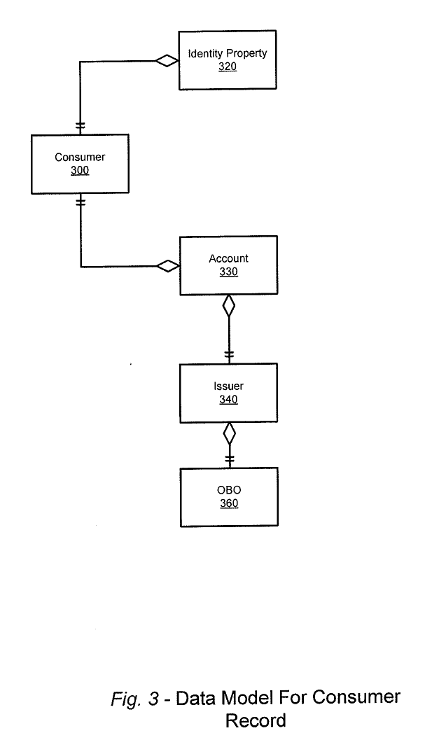

FIG. 3 is a data model diagram that illustrates an exemplary consumer record 300. As shown, the consumer record 300 includes an association with identity property records 320 and account records 330. The identity property records 320 can be used to store properties that represent the identity of the consumer. To illustrate, the identity property records 320 may store the mobile phone number of the consumer or any other suitable alias (e.g., email address). As shown in FIG. 3, each consumer record 300 is associated with account records 330 to store the consumer's account identifiers and account nicknames. In turn, each account record 330 may be associated with an issuer record 340. The issuer record 340 may store issuer configuration information. Additionally, each issuer record may be associated with an on-behalf-of record (OBO) enroller record 360, for those embodiments that allow an issuer to use a third party to provide enrollment service on-behalf-of the issuer.

With reference back to FIG. 2, the enrollment module 132 creates a consumer record and stores the consumer record in the enrollment database 136. A consumer key is generated by the enrollment module 132 to uniquely identify the consumer record. The consumer key is then transmitted to the first issuer 110. This is shown in message 17. With the consumer key, an issuer or a third party may identify a particular consumer record, such as the newly created consumer record now associated with consumer 106.

As described above, in some embodiments, the first issuer 110 can transmit additional consumer information to the service provider, such as an additional aliases (e.g., a phone number or email account) and account identifiers and account nicknames. In some embodiments, if the issuer requests adding an additional alias to the consumer record, the enrollment module 132 can create an identity property record 320 to store the alias and then associate the created identity property record with the consumer record associated with the consumer, as stored in the enrollment database 136. Such may be the case where the alias is an e-mail address. In other embodiments, the enrollment module 132 allows the consumer to update an alias (e.g., if the consumer changes phone numbers).

If account enrollment information (e.g., account identifier and nickname) is included in the create consumer request, an account record is created and associated with the consumer record in the enrollment database 136. An account record associated with the account identifier can be generated by the enrollment module 132. It can be used by the first issuer 110 to identify the account identifier and account nickname pair. In adding an account to the consumer record, the consumer may create one or more new nickname and account identifier combinations at the issuer's enrollment web site. The first issuer 110 may validate the account identifier using CVV2, address verification, or any other suitable method. Upon receiving a request from the consumer to enroll an account, the first issuer 110 can transmit an enroll account request (or alternatively referred to as a create consumer request; see message 6) to the enrollment module 132 using the consumer key and account nickname and account identifier information. The consumer record and its associated records are retrieved based on the consumer key. In some embodiments, the enrollment module 132 may verify that the phone number associated with the consumer is enabled. In other embodiments, the enrollment module 132 may verify the uniqueness of the account nickname submitted by the consumer compared to the account records already associated with the consumer record. Additionally, the enrollment module 132 can validate the account identifier using a MOD-10 digit check and/or match a first portion of the account identifier (e.g., the first six digits) to an entry in a table that associates issuers to account identifier (or portions of account identifiers). If the enrollment module 132 successfully verifies the account identifier, the enrollment module 132 can then create an account record for the account nickname and the account identifier in the database and associate the new account record with the existing consumer record.

In some embodiments, the enrollment module 132 may return an account identifier to the first issuer 110 that is associated with the account nickname and the account identifier.

Once enrolled, the consumer 106 may then utilize the service provided by the service providers on behalf of the first issuer 110. For example, the consumer 106 may visit a merchant website and pay for items using the mobile payment service provided by the service provider 104.

b. Subsequent Enrollment Across Issuers and/or for Other Services

Once the consumer 106 enrolls in a service via the enrollment module 132, the consumer 106 may subsequently enroll with the service provider 104 again if the consumer 106 enrolls in the service through another issuer. For example, a service provider 104 may provide the remote payment service described above on behalf of multiple issuers (e.g. first and second issuers 110 and 120). Accordingly, the consumer 106 may enroll one payment card associated with the first issuer 110 in the service and then, at some later point in time, enroll another payment card associated with the same or different issuer (e.g., the second issuer 120) in the same service. In some embodiments, the different issuers may operate separate branded enrollment websites to offer the service. In other embodiments, a third party enrollment service performs the operations associated with enrollment for the issuers.

In other embodiments, a subsequent enrollment may occur if the service provider provides multiple services on behalf of an issuer. In such cases, the enrollment in a second service will identify a consumer record matching the requested enrollment.

When an issuer is enrolling a consumer that is already enrolled in the service, the issuer and/or the service provider may attempt to verify that the consumer is the same consumer in each enrollment. Enrollment information associated with a previous enrollment may be used to verify the consumer. For example, the consumer may be verified using a partial account identifier that lacks some portion of the account identifier previously enrolled with the service. By providing an account identifier that lacks some portion thereof, the verification method may be comparatively secure. This is the case because a third party enrollment service may provide the interface to enroll with the service through the issuer. Such third parties may not be as trusted or it may be less desirable to provide the full sensitive account identifier. In another way, the entire account identifier is not transferred from an enrollment interface to the service provider. As shown, information may exchanged between the issuers (e.g., 110, 120) and the service provider 104 through a network such as the Internet (e.g., 160). As such, transmitting sensitive information such as an account identifier may pose a risk of being received by a fraudster.

Illustratively, in some embodiments, the middle portion of a PAN (primary account number) may be omitted, but the first six characters of the PAN and the last four digits of the PAN may be used to search an enrollment database. The first six characters of the PAN may be associated with a BIN (bank identification number) which is not confidential information. The last four digits of the PAN is typically printed on credit card receipts and is also generally not confidential. Thus, embodiments of the invention can use this non-confidential information, in conjunction with other information (e.g., an alias or phone number), to effectively identify an account associated with a consumer.

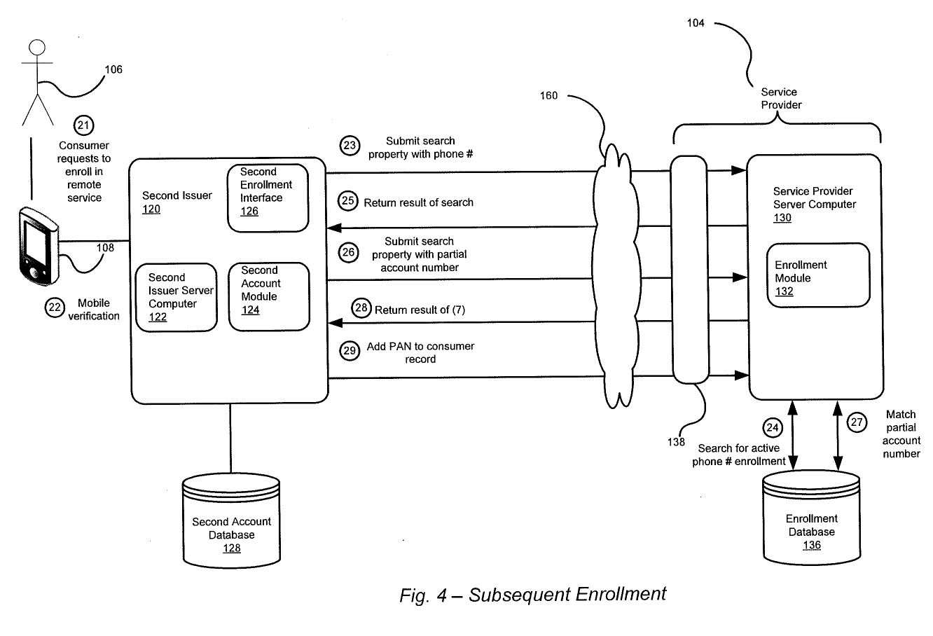

FIG. 4 illustrates functional elements involved in a subsequent enrollment of a consumer in a service offered by a service provider on behalf of an issuer. As describe above with reference to FIG. 2, the consumer 106, for example, has already visited an enrollment site maintained or branded by the first issuer 110 and has registered a payment card associated with the first issuer 110 with the service provided by service provider 104 on behalf of issuer 110. FIG. 4 shows the consumer 106 now enrolling with the service provided by the service provider 104 on behalf of different issuer, such as the second issuer 120. Such is the case where the consumer is enrolling a different payment card in the same service. For example, as part of message 21, the consumer 106 may enter information such as an account identifier, phone number, name, and expiration date with regards to an account of second issuer 120. Additional information may also be entered by the consumer 106. For example, the consumer 106 may enter address information, email address, shopper identification, an account verification value, and consumer password.

After the consumer 106 requests enrollment in the service offered by the second issuer 120, the second issuer 120 confirms ownership of the mobile phone number. This is shown as message 22. In some embodiments, the second issuer 120 confirms ownership of the phone number using an out-of-band process, as described above.

Once ownership of the mobile phone is confirmed, the second issuer 120 can determine whether the consumer 106 is already enrolled with the service provider 104. To confirm enrollment, the second issuer 120 may transmit a search request to the enrollment module 132 operated by the remote server computer 130. In one example embodiment, the second issuer 120 transmits a “search property request” to the enrollment module 132. This is shown as message 23. As described above, the search property request can refer to a request to the enrollment module 132 to search for a consumer record based on a property. A phone number is an example of a search property. An e-mail address is another example of a search property that can form the basis of a search property request.

Responsive to receiving a search request, the enrollment module 132 then searches the enrollment database 136 to determine whether the search property matches an identity property record associated with a consumer record. This is shown as message 24. As described above, with reference to the initial enrollment shown in FIG. 2, the enrollment database 136 includes a consumer record associated with an identity property record corresponding to the phone number of the consumer. As such, the enrollment module 132 can match the phone number transmitted in message 23 of FIG. 4 with the consumer record created based on message 16 of FIG. 2. Upon matching the consumer phone number with the consumer record, the enrollment module 132 returns an indication that consumer is already enrolled with the service. This is shown as message 25. According to some embodiments, the enrollment module 132 may return a consumer key that is associated with the consumer record.

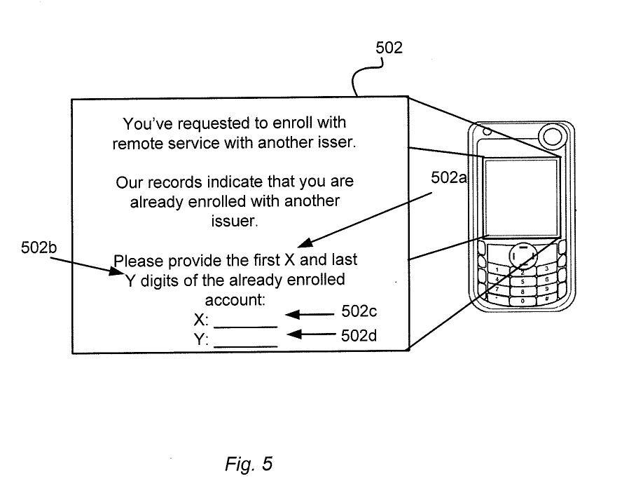

Responsive to receiving an indication that the consumer has previously enrolled, the second issuer 120 may then verify that the identity of the consumer 106 is the same for both the initial enrollment and the enrollment currently being requested. Accordingly, the second issuer 120 may obtain information regarding the initial enrollment of the consumer. For example, FIG. 5 shows a user interface 502 that requests a first portion 502c and second portion 502d of an account identifier. In some embodiments, the first portion 502c includes a set number of characters 502a (e.g., six digits) and the second portion 502d includes another set number of characters 502b (e.g., four digits). It is noted that the first six and last four digits of an account identifier are used merely as an example and other such information can be utilized by embodiments described herein. For example, one embodiment may obtain only a first portion of the account identifier. Other example embodiments may additionally obtain a verification value, such as a CVV2 value imprinted on the payment card previously enrolled with the service.

Returning to FIG. 4, once the second issuer 120 receives the first and second portions of the account identifier, the second issuer 120 may send a verification message to verify that an account is enrolled with the consumer 106. This is shown as message 26. The search request may include the consumer key and verification information of a currently enrolled account associated with the consumer. For example, the second issuer 120 may send a partial account identifier that includes the first six characters of an account identifier and the last four characters of the account identifier, but not the middle portion of the account identifier, to the service provider server computer 130. The enrollment module 132 then receives the consumer key and the verification information. The enrollment module 132 then identifies the consumer record based on the consumer key, and searches the account records associated with the consumer record for an account identifier that matches the first and second portions of the account identifier.

If the first six and last four characters of the account identifier match an account identifier found in an account record associated with the consumer record, the enrollment module 132 may return an indication that the consumer is validated (e.g., a TRUE status). Upon receiving the indication that the consumer is enrolled, the issuer 120 may continue and edit the enrollment. This is shown as messages 27 and 28. Editing the enrollment may include associating a new account record with the consumer record. The new account record may correspond to an account identifier associated with the issuer 120. Editing the enrollment may additionally or alternatively include editing the account information, such as a nickname associated with the account. The PAN may then be added to the consumer record (message 29).

### IV. Method

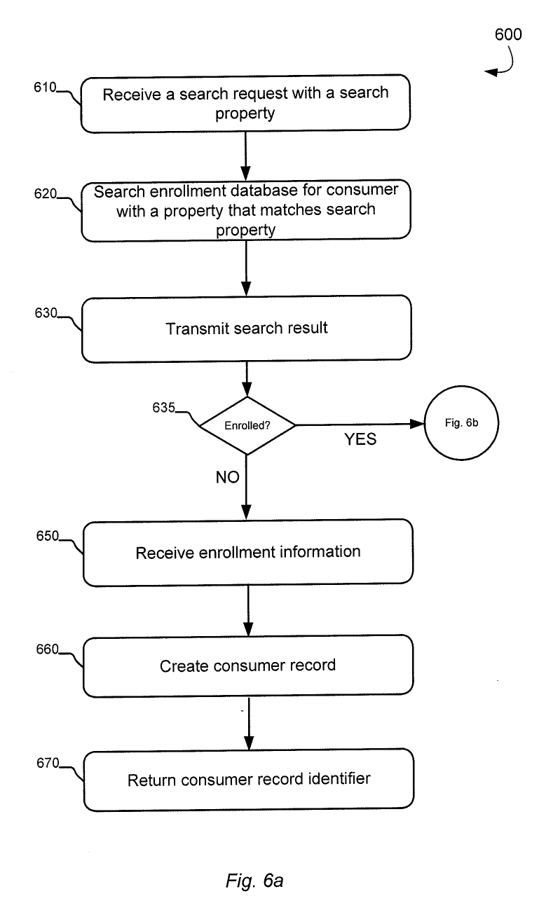

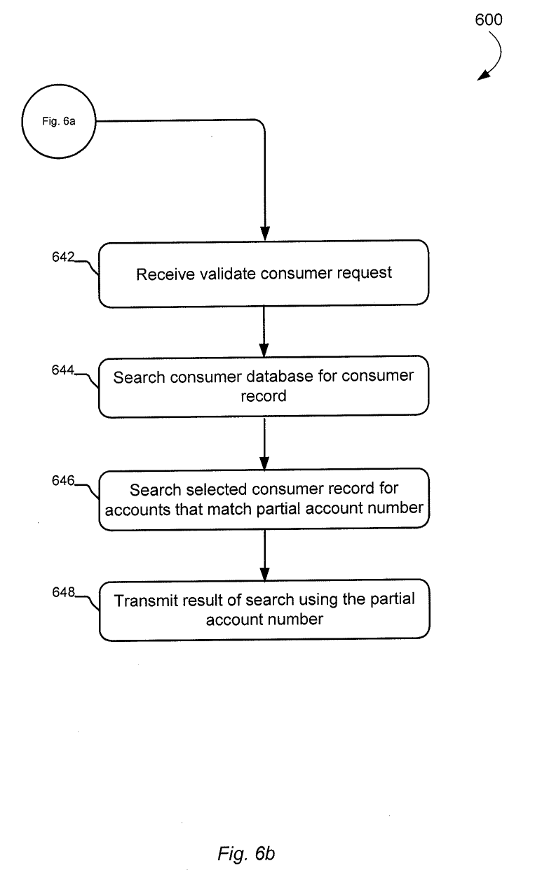

FIGS. 6a and 6b are flow diagrams that show a generalized method 600 for verifying a consumer enrollment using a partial account identifier. The various operations of the method 600 can be performed, for example, by the enrollment module 132 operated by the service provider server computer 130. Various operations of the method 600 can also be performed by the issuer server computers 112 and/or 122. These server computers may use one or more computers or network of computers to perform some or all of the acts within the method. Still further, various operations of the method 600 can be performed by a computer operated by a consumer (e.g., 108).

Verifying a consumer begins when the enrollment module 132 receives a request to search for a consumer record. This is shown as step 610. The request may include a property to be used in the search for the consumer record. As described above, a property may be an alias such as a phone number or an email, or any other property that uniquely identifies a consumer in the enrollment system 100. Upon receiving the request to search for a consumer record, an enrollment database is searched for a consumer record that is associated with a property record that matches the search property received at step 610. This is shown as step 620. In an example embodiment, the enrollment database 136 is searched for a consumer record associated with a particular phone number. The result of the search performed at step 620 is then returned at step 630. Such results may be transmitted to an issuer that is offering a service, wherein the service is provided at least in part by a service provider. The search result indicates whether a consumer record with a property matching the search property is stored in the enrollment database 136. To indicate that the no such record exists, the result can have a value representing false, null, zero, negative, or any similar value. If the consumer record exists, the result can have a value representing true, a consumer key to the consumer record, or any other similar value.

The step performed next may depend on whether a matching consumer record is found in the enrollment database, as indicated in decision 635. For example, if the consumer record indicates that the consumer is not yet enrolled (e.g., no consumer record was found at step 620), the enrollment module 132 may receive enrollment information from the issuer (step 650). As described above, enrollment information may be obtained through the enrollment interface operated by the issuer and then transmitted to the service provider. Further, enrollment information may include an alias for the consumer, account information such as an account identifier, contact information such as street address, city, and state, and any other information. Enrollment may also include service specific information. For example, according to the example service described above, enrollment information may include account nicknames to identify a specific account identifier. Using the enrollment information, a consumer record can be created and stored in the enrollment database 136 (step 660) To complete enrollment, the consumer record identifier can be returned to the issuer, wherein the consumer record identifier can be used to later identify the consumer record (step 670).

With reference to FIG. 6b, if the consumer was previously enrolled, the enrollment module 132 may receive a request to validate the consumer (step 642). The validate consumer request may include a partial account identifier that was previously enrolled. For example, the partial account identifier may be missing a portion of the entire identifier. To illustrate, the partial account identifier may include the first six and last four characters of the actual account identifier. As such, the partial account identifier is missing the middle characters. The validate consumer request may also include a consumer key that identifies the specific record to use in the validation. The consumer key may have been previously transmitted as part of the result of step 630.

Upon receiving the partial account identifier, the enrollment module 132 may search the enrollment database to determine if the consumer is associated with a account identifier that matches the partial account identifier (step 644). In an example embodiment, a consumer record is identified using a consumer index received as part of the validate consumer request. In other embodiments, the consumer record is searched using an alias as a search property, as described above. Once the consumer record is identified, the enrollment module 132 may search the consumer record to determine if an account record associated with the consumer record matches the partial account identifier (step 646). The result of this search is transmitted at step 648.

### IV. Computer Systems

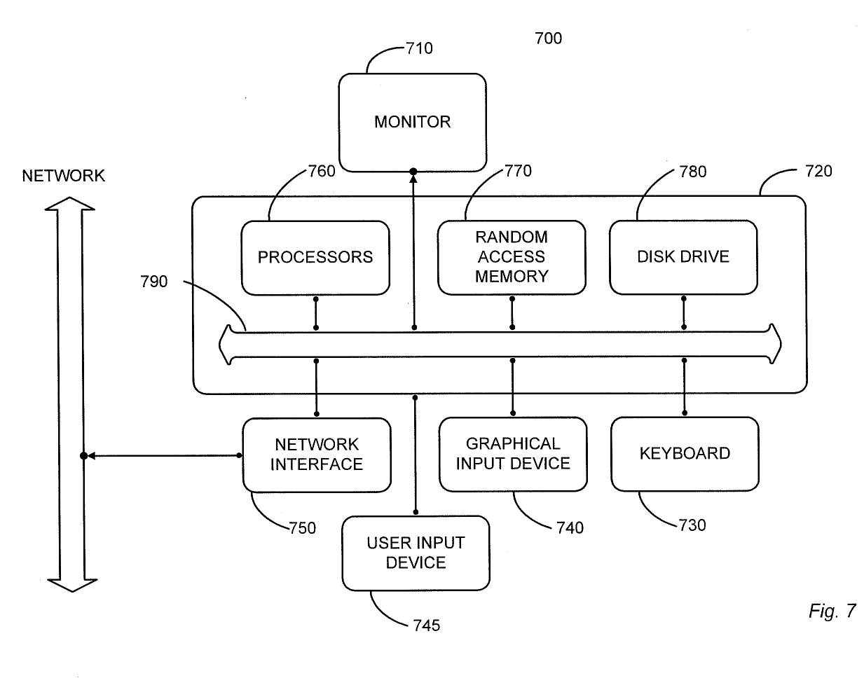

Any of the elements in figures described herein can use any suitable number of subsystems to facilitate the functions described herein. System 700 in FIG. 7 is representative of a computer system capable of embodying various aspects of the present invention. The computer system can be present in any of the elements in figures described herein, including configuration device 115, for example. Similarly, the various participants, entities and elements in FIG. 1 may operate one or more memory apparatuses to facilitate the functions described herein. It will be readily apparent to one of ordinary skill in the art that many other hardware and software configurations are suitable for use with the present invention.

For example, the computer may be a desktop, portable, rack-mounted or tablet configuration. Additionally, the computer may be a series of networked computers. Further, the use of other micro processors are contemplated, such as Xeon™, Pentium™ or Core™ microprocessors; Turion™ 64, Opteron™ or Athlon™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board. Various embodiments may be based upon systems provided by daVinci, Pandora, Silicon Color, or other vendors.

In one embodiment, computer system 700 typically includes a display 710, computer 720, a keyboard 730, a user input device 740, computer interfaces 750, and the like. In various embodiments, display (monitor) 710 may be embodied as a CRT display, an LCD display, a plasma display, a direct-projection or rear-projection DLP, a microdisplay, or the like. In various embodiments, display 710 may be used to display user interfaces and rendered images.

In various embodiments, user input device 740 is typically embodied as a computer mouse, a trackball, a track pad, a joystick, wireless remote, drawing tablet, voice command system, and the like. User input device 740 typically allows a user to select objects, icons, text and the like that appear on the display 710 via a command such as a click of a button or the like. An additional specialized user input device 745, such a magnetic stripe, RFID transceiver or smart card reader may also be provided in various embodiments. In other embodiments, user input device 745 include additional computer system displays (e.g. multiple monitors). Further user input device 745 may be implemented as one or more graphical user interfaces on such a display.

Embodiments of computer interfaces 750 typically include an Ethernet card, a modem (telephone, satellite, cable, ISDN), (asynchronous) digital subscriber line (DSL) unit, FireWire interface, USB interface, and the like. For example, computer interfaces 750 may be coupled to a computer network, to a FireWire bus, or the like. In other embodiments, computer interfaces 750 may be physically integrated on the motherboard of computer 720, may be a software program, such as soft DSL, or the like.

RAM 770 and disk drive 780 are examples of computer-readable tangible media configured to store data such user, account and transaction level data, calculated aggregated data, super keys, sub keys and other executable computer code, human readable code, or the like. Other types of tangible media include magnetic storage media such as floppy disks, networked hard disks, or removable hard disks; optical storage media such as CD-ROMS, DVDs, holographic memories, or bar codes; semiconductor media such as flash memories, read-only-memories (ROMS); battery-backed volatile memories; networked storage devices, and the like.

In the present embodiment, computer system 700 may also include software that enables communications over a network such as the HTTP, TCP/IP, RTP/RTSP protocols, and the like. In alternative embodiments of the present invention, other communications software and transfer protocols may also be used, for example IPX, UDP or the like.

In various embodiments, computer 720 typically includes familiar computer components such as a processor 760, and memory storage devices, such as a random access memory (RAM) 770, disk drives 780, and system bus 790 interconnecting the above components.

In some embodiments, computer 720 includes one or more Xeon microprocessors from Intel. Further, in the present embodiment, computer 720 typically includes a UNIX-based operating system.

It should be understood that embodiments of the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++or Perl using, for example, conventional or object-oriented techniques. The software code may be stored as a series of instructions, or commands on a non-transitory computer readable medium, such as a random access memory (RAM), a read only memory (ROM), a magnetic medium such as a hard-drive or a floppy disk, or an optical medium such as a CD-ROM. Any such non-transitory computer readable medium may reside on or within a single computational apparatus, and may be present on or within different computational apparatuses within a system or network.

The above descriptions are illustrative and are not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. For example, any of the above described analytics may be combined with any other suitable analytics in any suitable manner in methods or systems according to embodiments of the invention. Thus, although specific features are separately described in this application, they may be combined in certain embodiments of the invention.

A recitation of “a”, “an” or “the” is intended to mean “one or more” unless specifically indicated to the contrary.

What is claimed is:

1. A method comprising:
receiving a verification message with information that includes a first portion but not a second portion of an account identifier associated with an account of a consumer; and
searching, using a computer, for the account using the information of the verification message.

2. The method of claim 1, wherein the first portion is the first six characters of the account identifier.

3. The method of claim 1, wherein the information of the verification message includes a third portion of the account identifier.

4. The method of claim 3, wherein the third portion is the last four characters of the account identifier.

5. The method of claim 1, further comprising:
receiving an alias associated with the consumer; and
searching a database for a record with a property that matches the alias.

6. The method of claim 1, wherein the account is associated with an issuer.

7. The method of claim 6, wherein the verification message is received from a different issuer.

8. The method of claim 1, wherein the account has been previously enrolled in a first service, and the verification message is received in response to a request to enroll in a second service.

9. The method of claim 1, further comprising:
responsive to finding no accounts that match the information of the verification request, creating a consumer record associated with the consumer in the database.

10. The method of claim 1, further comprising:
responsive to finding the account using the information of the verification request, sending an indication that the consumer is in the database.

11. An apparatus comprising:
a computer coupled to a database, wherein the computer comprises a processor and a computer-readable storage medium coupled to the processor, the computer readable storage medium comprising code executable by the processor for implementing a method comprising:
receiving a verification message with information that includes a first portion but not a second portion of an account identifier associated with an account of a consumer; and
searching for the account using the information of the verification message.

12. The apparatus of claim 11, wherein the first portion is the first six characters of the account identifier.

13. The apparatus of claim 11, wherein the information of the verification message includes a third portion of the account identifier.

14. The apparatus of claim 13, wherein the third portion is the last four characters of the account identifier.

15. The apparatus of claim 11, wherein the method further comprises:
receiving an alias associated with the consumer; and
searching a database for a record with a property that matches the alias.

16. The apparatus of claim 11, wherein the account is associated with an issuer.

17. The apparatus of claim 16, wherein the verification message is received from a different issuer.

18. The apparatus of claim 11, wherein the method further comprises:
responsive to finding no accounts that match the information of the verification request, creating a consumer record associated with the consumer in the database.

19. The apparatus of claim 11, wherein the method further comprises:
responsive to finding the account using the information of the verification request, sending an indication that the consumer is in the database.

20. A computer readable medium storing commands for causing a processor to implement the method of claim 1.
